(19) United States
(12) Patent Application Publication
(10) Pub. No.: US 2005/0263943 A1
(43) Pub. Date: Dec. 1, 2005

(54) Device and a method for molding an elastomer bearing onto a stabilizer bar

(75) Inventor: Phillippe Noullez, Rue des Treelles (FR)

Correspondence Address: KENYON & KENYON, 1500 K STREET NW, SUITE 700, WASHINGTON, DC, 20005, US

(73) Assignee: ALLEVARD REJNA AUTOSUSPENSIONS

(21) Appl. No.: 11/135,373

(22) Filed: May 24, 2005

(30) Foreign Application Priority Data
May 25, 2004 (FR) 04 05612

(51) Int. Cl. B29C 31/00

(52) U.S. Cl. 264/275; 264/486; 425/129.1

(57) ABSTRACT

The present invention provides a method of molding an elastomer bearing onto a stabilizer bar in which the following steps are performed: placing a stabilizer bar across a mold; injecting an elastomer into an empty space formed between a first portion of the bar and the mold; hot-curing said elastomer, firstly by induction heating the mold using first induction heating means, and secondly by induction heating said first bar portion by second induction heating means disposed around two second bar portions situated on either side of the mold; and unmolding the bearing that is obtained once the elastomer has cured. The invention also provides apparatus enabling the method of the invention to be implemented.

The present invention relates to a method of molding an elastomer bearing onto a stabilizer bar, and to a device enabling such a method to be implemented. Stabilizer bars are used in motor vehicle suspensions. Each stabilizer bar, also known as an anti-roll bar, is connected by lever to the suspension for each wheel on a given axle and is secured to the bodywork or to the suspension cradle of the vehicle by two resilient hinge bearings.

### BACKGROUND OF THE INVENTION

Such stabilizer bars are generally made from a forged steel bar shaped so as to provide a single part constituting both the rectilinear portion and the levers of each bar. The resilient hinge bearings that surround portions of the bar are made of elastomer or sometimes of polyurethane and they are enclosed in a housing that is secured to the bodywork or to the suspension cradle.

In a known embodiment, the bearings are molded onto the bar as follows. Firstly, the stabilizer bar is preheated using heating means. The preheated bar is then placed between the plates of an injection press, passing through a mold suitable for defining an enclosed empty space around a portion of the bar and having the shape of the bearing that is to be made. Electrical heater resistors placed in contact with the mold serve to heat it by conduction. A composition comprising at least one elastomer is then injected into the above-specified closed empty space and, under the effect of temperature, the composition cures in order to form the bearing.

In order to ensure that the bearings are firmly secured to the corresponding portions of bar, these portions are generally coated, prior to the composition being injected into the mold, with a bonding agent that enables the bearing to bond onto the bar. Under the effect of temperature, this agent cures and forms bonds with the elastomer chains of the composition.

Said composition generally comprises natural rubber (although it is also possible to use synthetic rubber) to which there may be added curing agents, accelerators, plasticizers, . . . . With rubber, the curing or cross-linking of the polymer chains is known as vulcanization.

It will be understood that the heating of the mold and the preheating of the bar determine the outcome of the procedure, since firstly they deliver the heat required for curing the composition and thus for forming the bearing, and secondly they deliver the heat required for curing the bonding agent and thus for securing the bearings to the bar.

In a known method, the time needed to make elastomer bearings lies in the range five minutes to seven minutes.

### OBJECTS AND SUMMARY OF THE INVENTION

The present invention seeks to increase the rate at which elastomer bearings can be fabricated by reducing the time needed for curing the composition and the bonding agent, if any.

During the research that has led to the present invention, the Applicant has found that slow bonding in the prior method can be explained mainly by the fact that once the composition has been injected, the poor thermal conductivity of the composition prevents heat from propagating from the mold to the bar. The preheating of the bar is then found to be insufficient to provide the heat needed for rapid curing of the fraction of the composition that is situated close to the bar and that is too far away from the mold to be heated thereby, and also for curing the bonding agent used, if any.

The present invention provides a method of molding an elastomer bearing onto a stabilizer bar, the method comprising the following steps: placing a stabilizer bar across a mold suitable for leaving a closed empty space having the shape of said bearing around a first portion of said bar; injecting a composition comprising at least one elastomer into said empty space; hot-curing said composition by induction heating the mold and by heating said first portion of the bar by using induction heating means disposed around at least one second portion of said bar that is situated outside the mold; and unmolding the resulting bearing after the composition has been cured.

The fact of not merely preheating the first bar portion but of heating it after the composition has been injected, enables an additional quantity of heat to be delivered for causing that portion of the composition that is furthest away from the mold to be cured quickly, together with the bonding agent, if any.

The composition injected into the mold is thus heated sufficiently from the inside by the first bar portion, and from the outside by the mold, to enable curing to take place more quickly than in the above-described previously-known fabrication method. The Applicant has thus managed to divide the time required for curing substantially by two, thereby reducing it to under three minutes.

Furthermore, it should be observed that the invention makes use of induction as a heating technique. By means of this technique, the mold and the first bar portion are brought quickly and easily up to the desired temperature, and indeed it is then possible, to vary said temperature accurately and quickly.

Advantageously, the first portion of the stabilizer bar is heated, at least in part, by conducting heat from the second portion(s) towards the first bar portion.

It is possible to heat the first bar portion in part by induction by causing it to be crossed by varying magnetic flux, at least at its ends.

In a particular implementation of the invention, the mold and the second portion(s) of the stabilizer bar are heated prior to injecting the composition.

Advantageously, in order to facilitate and reinforce bonding of the elastomer bearing on the first bar portion, a bonding agent is placed thereon prior to injecting the composition into the mold.

Also advantageously, different induction heating means are used for heating the mold and for heating the second bar portion(s), and said induction heating means can be controlled independently.

This makes it possible to adjust the temperatures of the mold and of the bar independently, thereby enabling curing conditions for the composition and for the bonding agent to be optimized. For example, the induction heating means can be adjusted so that the temperatures of the mold and of the bar portion lie in the range 160° C. to 220° C., and preferably in the range 180° C. to 200° C.

In practice, these temperature ranges turn out to be well adapted to most elastomers and bonding agents of the kind generally used, and more particularly, to natural rubber and to bonding agents that are compatible therewith.

The present invention also provides a device enabling the above-described method to be implemented. Such a device for molding an elastomer bearing onto a bar comprises a mold suitable for leaving a closed empty space having the shape of said bearing around a first portion of stabilizer bar, an injector for injecting a composition comprising at least one elastomer into said empty space, first induction heating means for heating said mold, and second induction heating means for heating at least one second portion of the bar that is situated outside the mold and in the vicinity thereof.

The advantages of such a device are naturally analogous to those of the above-described method. In addition, since the first and second heating means are situated in the same device, adjacent to each other, the space occupied by the device is smaller than the space occupied in installations of prior art type, where the means for preheating the bar and the means for heating the mold occupy two distinct sites.

In a particular embodiment of the device, the second heating means are disposed on either side of the mold. Thus, the first portion is heated, at least in part or possibly in full, by heat being conducted from the bar portions surrounding it, thereby improving heating.

### BRIEF DESCRIPTION OF THE DRAWINGS

The various characteristics and the main advantages of the invention will be better understood on reading the following description of the particular embodiment of the device of the invention that is given by way of example and illustrated in the following figures:

FIG. 1 is an outside view showing the front of the device comprising two half-assemblies with two stabilizer bars passing therethrough, each half-assembly comprising a support, a half-inductor, and a half-shell;

FIG. 2 is a section view through the FIG. 1 device on plane II, when the two half-assemblies are assembled together;

FIG. 3 is an outside view of the two half-inductors of FIG. 1; and

FIG. 4 is an outside view of rear second means for induction heating, comprising a half-inductor embedded in a resin base.

### MORE DETAILED DESCRIPTION

The device of the invention as shown in the figures is for simultaneously molding two elastomer bearings 10 on two stabilizer bars 12. The device has first induction heating means 22 comprising two half-inductors 22a and 22b connected to a first high frequency electricity generator (not shown), and second induction heating means (40a, 40b) each formed by at least one conductor element 41a, 41b of undulating shape, likewise connected to a high frequency electricity generator.

The device also comprises control means (not shown) for independently controlling the first and second induction heating means 22 and 40a, 40b.

The device further comprises a mold formed by two half-shells 14a and 14b that are secured to respective supports 16a and 16b. These supports are themselves respectively secured to bottom and top plates 18a and 18b of an injection press by any appropriate fastener means, e.g. by screws. Advantageously, the supports 16a and 16b are not conductive (i.e. are insulators), so that they are not induction heated.

On their sides, said supports 16a and 16b present spacers 20 suitable for holding each support at a distance from the associated half-shell 14a, 14b. A gap is thus provided between the support and the corresponding half-shell. One of the two half-inductors 32a or 32b is housed in said gap.

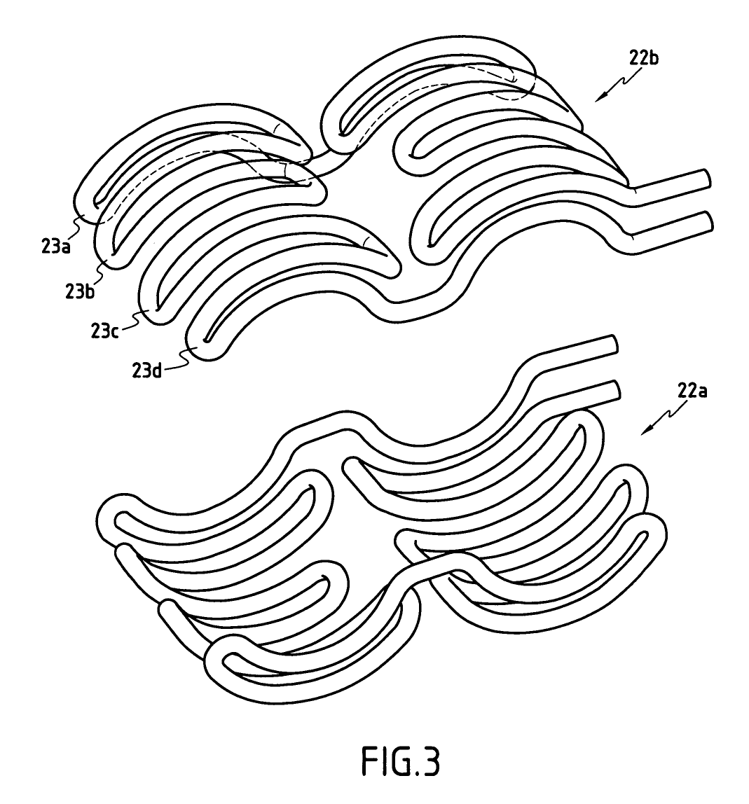

The two half-inductors 22a and 22b are shown in detail in FIG. 3. Each of them is the result of shaping a conductor element, specifically a metal tube, in a particular way. The tube is initially folded so as to give it an undulating configuration approximately reproducing the general appearance of a sinewave, with the amplitude or height of the undulations being considerably greater than their width. If only the portion of the half-inductor 22b that is shown on the left of FIG. 3 is taken into consideration, there can be seen four undulations 23a, 23b, 23c, and 23d. After the tube has been folded, it is given a shape that is complementary to the shape of the outside wall of a half-shell 14a or 14b so that the tube fits closely thereover but without coming into contact therewith. In the present case, the outside walls of the half-shells 14a and 14b and of the half-inductors 22a and 22b are semicylindrical in shape, with the radius of each half-inductor being greater than that of the outside wall of the associated half-shell.

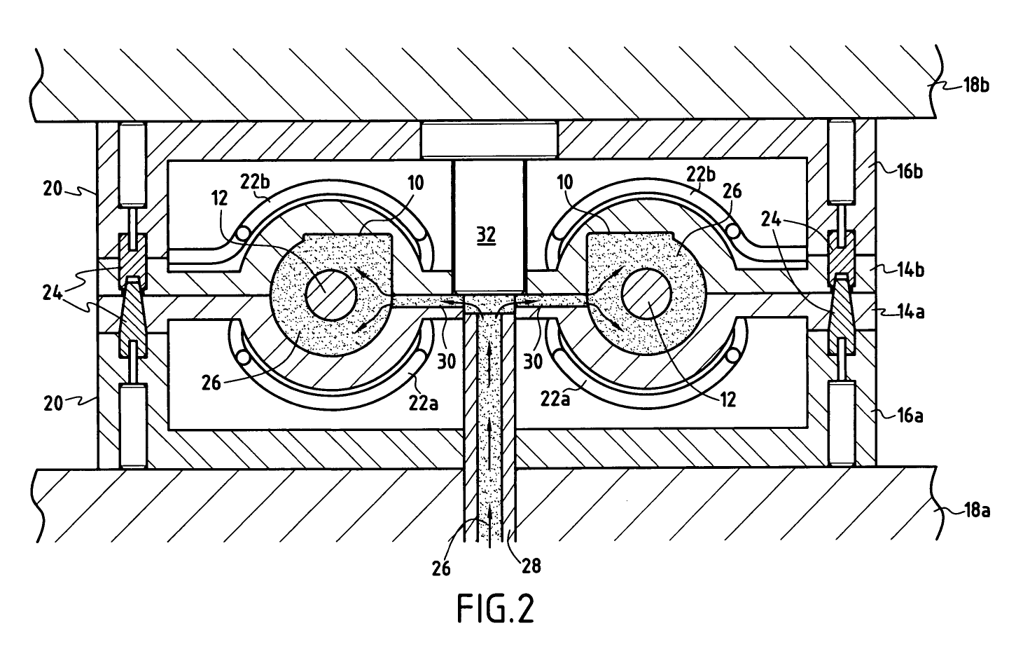

As shown in FIG. 2, once assembled together, the two half-inductors 22a and 22b form two inductor coils suitable for inducing currents within the half-shells 14a and 14b.

The bar and the mold mentioned in the present application are made of a metal or an alloy that is conductive, and are suitable for conveying electric currents induced by variations in the magnetic fields created by the inductors, these induced currents causing them to be heated.

The second induction heating means 40a, 40b are situated outside the mold and in the vicinity thereof, on either side of the mold. Thus, front and rear second heating means 40a and 40b can be distinguished, each comprising a conductor element 41a or 41b of undulating configuration. In the example shown, the two elements 41a and 41b present configurations that are different, given the shapes of the front and rear second portions 15a and 15b of the stabilizer bar that these elements surround, at least in part.

Like the conductor elements of the half-inductors 22a and 22b, the conductor elements 41a and 41b of the second heating means 40a and 40b are tubes of metal, e.g. copper, that are folded in such a manner as to given them particular configurations. Preferably, the conductor elements 41a and 41b respectively surround more than half of the outside peripheries of the second bar portions 15a and 15b.

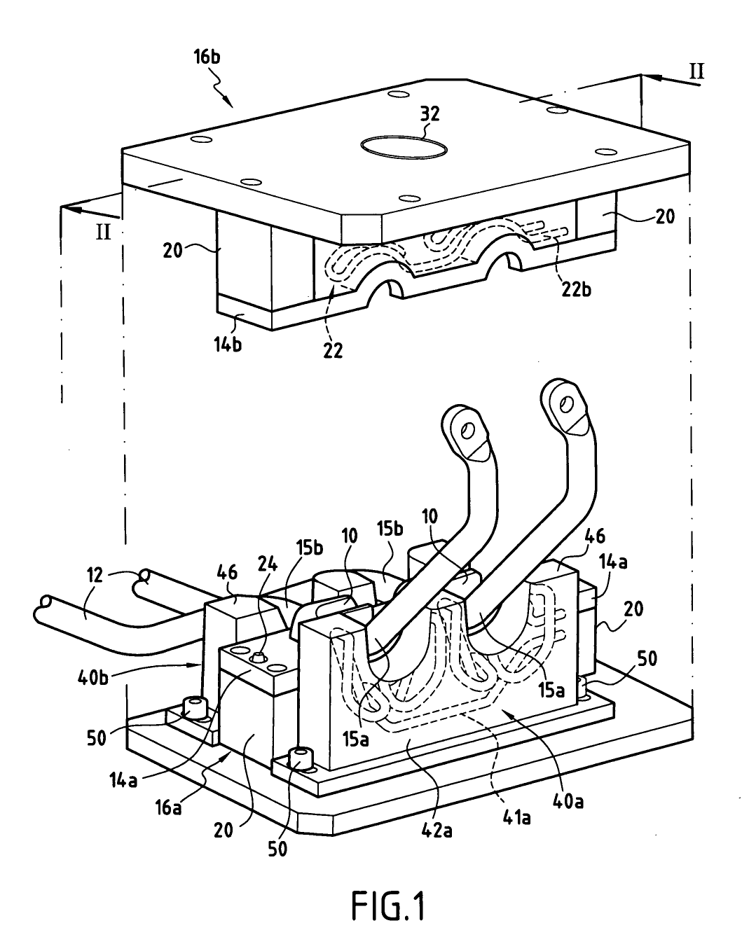

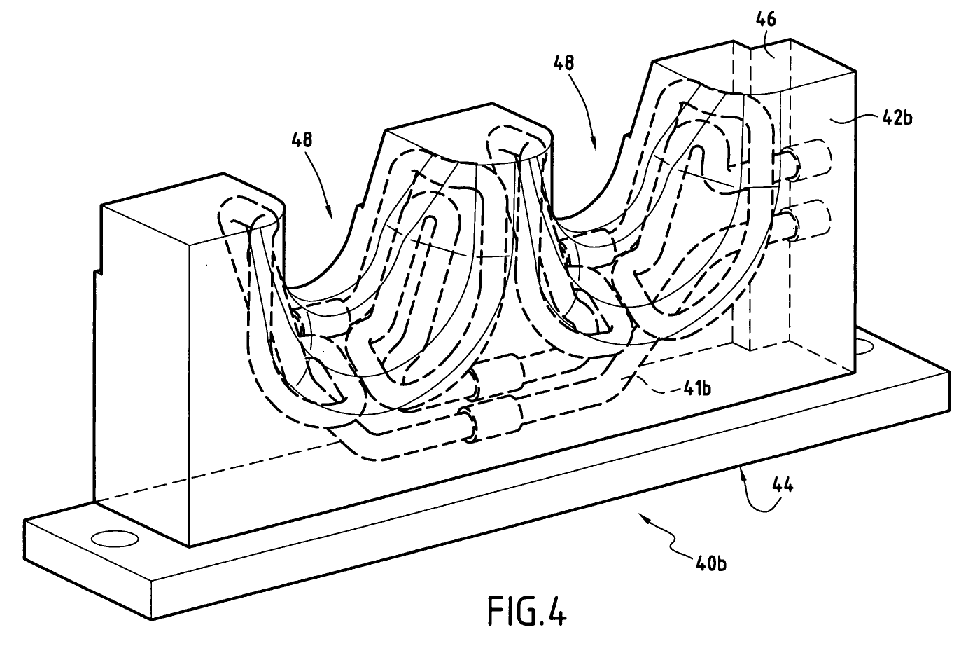

Particular configurations for the conductor elements 41a and 41b that have given satisfaction are shown in FIGS. 1 and 4 as examples. This representation of these configurations, as such, is considered as being a protected characteristic.

The tubes forming the first and second heating means themselves carry induced currents and are themselves subjected to a heating phenomenon, so a cooling fluid is caused to circulate inside the tubes.

As shown in FIGS. 1 and 4, each of the conductor elements 41a and 41b is embedded in a respective base 42a or 42b made of resin. In practice, each base 42a, 42b is molded around the respective conductor element 41a, 41b. Each resin base presents a bottom face 44 for resting on the bottom plate 18a of the injection press, and a top face 46 having two notches 48 formed therein for receiving the second bar portions 15b (but without coming into contact therewith). The shapes of the conductor elements 41a and 41b follow the shapes of the notches 48 so that these elements lie immediately below the surfaces of the notches 48.

In this example, each resin base 42a and 42b is secured to the bottom plate 18a of the press via its bottom face 44 by means of screws 50. It should be observed that these bases can be secured in the same way to the top face 18b.

In addition, centering means 24 are provided on each half-shell 14a, 14b so as to ensure that the half-shells are correctly positioned relative to each other when the plates 18a and 18b of the press carrying the half-shells 14a and 14b are moved towards each other around the bar 12. These means include at least one stud of tapering shape disposed on an edge of one of the two half-shells 14a suitable for being received in a cavity of complementary shape presented by the other half-shell 14b.

An injector 28 into which the composition 16 comprising at least one elastomer is injected opens out into the center of one of the two half-shells 14a. Two diametrically opposite channels 30 connect the circular orifice of the injector 28 to the two closed empty spaces formed around the bars 12 by the half-shells 14a and 14b, thus enabling said composition 26 to be distributed inside each of the two spaces. An abutment 32 bearing against the top plate 18b of the injection press passes through the other half-shell 14b and is situated facing the orifice of the injector 28 so as to provide reaction against the injection. The presence of this abutment 32 avoids any deformation of the half-shell 14b through which it passes that might otherwise be associated with injecting the composition 26.

Now that the structure of the device described above is well understood, it is appropriate to mention the various steps in an example of the molding method implemented using such a device.

Firstly, the first portions 13 of two stabilizer bars 12 on which it is desired to secure elastomer bearings are covered in a bonding agent that is compatible with the bars and with the selected elastomer.

Thereafter, these two bars 12 are slid between the bottom and top plates 18a and 18b of the injection press, and the first portions 13 of these bars are placed across the two spaces provided for this purpose in the half-shell 14a.

The plates 18a and 18b are then moved towards each other so that the two half-shells 14a and 14b come into contact and surround each first bar portion 13, thereby creating respective closed empty spaces around each of the first portions 13, the spaces having the shape of the bearings that are to be molded.

The two electricity generators respectively connected to the half-inductors 22a and 22b and to the conductor elements 41a and 41b of the second heating means 40a and 40b are then adjusted so that each half-shell of the mold and each second portion 15a, 15b of a stabilizer bar is heated by induction prior to injecting the molding composition 26.

The mold is heated by induction, and the first bar portion 13 is heated by heat being conducted from the second portions 15a, 15b that are themselves heated by induction. In order to limit heat losses during conduction, it is clearly desirable, where the shapes of the bar and of the mold make this possible (as is the case in the example of the device that is shown), for the second bar portions 15a and 15b to be situated as close as possible to the first bar portion 13.

A composition 26 comprising at least one elastomer is then injected via the injector 28 and the two channels 30 into the insides of said closed empty spaces.

The first and second heating means continue to heat the bars 12 and the half-shells 14a and 14b during and after injection of the composition 26 so as to contribute to curing both the composition and the bonding agent. Since the supply of heat is well adapted to the energy requirements of the endothermic curing reactions, the duration of these reactions is optimized.

Once the reactions have terminated, the plates 18a and 18b of the press are moved apart and the stabilizer bars 12 having bearings 10 that have just been molded thereon are removed so as to leave room for new bars which will in turn be heated prior to injecting the composition 26.

1. A method of molding an elastomer bearing onto a stabilizer bar, the method comprising the following steps: placing a stabilizer bar across a mold suitable for leaving a closed empty space having the shape of said bearing around a first portion of said bar; injecting a composition comprising at least one elastomer into said empty space; hot-curing said composition by induction heating the mold and by heating said first portion of the bar by using induction heating means disposed around at least one second portion of said bar that is situated outside the mold; and unmolding the resulting bearing after the composition has been cured.

2. A method according to claim 1, wherein said first portion of the stabilizer bar is heated, at least in part, by heat conduction from the second portion towards the first portion of the bar.

3. A method according to claim 1, wherein said mold and said second portion of the stabilizer bar are heated by induction prior to injecting said composition.

4. A method according to claim 1, wherein a bonding agent is deposited on said first portion of the stabilizer bar prior to injecting said composition.

5. A method according to claim 1, wherein different induction heating means are used for heating said mold and for heating said second portion of the stabilizer bar.

6. A method according to claim 5, wherein said induction heating means are controlled independently.

7. A method according to claim 5, wherein said induction heating means are controlled in such a manner that the temperatures of the mold and of the first portion of the bar lie in the range 160° C. to 220° C.

8. A device for molding an elastomer bearing on a stabilizer bar, the apparatus comprising a mold suitable for leaving a closed empty space having the shape of said bearing around a first portion of stabilizer bar, an injector for injecting a composition comprising at least one elastomer into said empty space, first induction heating means for heating said mold, and second induction heating means for heating at least one second portion of the bar situated outside the mold and in the vicinity thereof.

9. A device according to claim 8, wherein said second induction heating means are disposed on either side of said mold.

10. A device according to claim 8, further comprising control means for controlling said first and second induction heating means independently of each other.

11. A device according to claim 8, wherein said mold is made up of two half-shells, and wherein said first induction heating means comprise two half-inductors each formed by a conductor element of undulating configuration enveloping the outside wall of a respective one of the half-shells.

12. A device according to claim 11, further comprising non-conductive supports associated with said half-shells, the support presenting on their sides spacers suitable for maintaining each support at a distance from the associated half-shell, and wherein each above-mentioned half-inductor is housed between one of the two supports and the associated half-shell.

13. A device according to claim 12, wherein each support is secured to a plate of an injection press.

14. A device according to claim 11, wherein said injector passes through one of the half-shells, with an abutment forming a reaction against injection being situated on the other half-shell, facing said injector.

15. A device according to claim 8, wherein said second induction heating means comprise at least one conductor element of undulating configuration, said conductor element surrounding at least part of the second portion of stabilizer bar.

16. A device according to claim 11, wherein the conductor element of the first and/or second heating means is/are constituted by a metal tube having a liquid flowing therein that is suitable for cooling said tube.

17. A device according to claim 15, further comprising at least one resin base having the conductor element of the second heating means embedded therein.

18. A device according to claim 17, wherein each support is secured to a plate of an injection press, and wherein said resin base is secured to one of the two plates of the injection press.
